(19) United States
(12) Patent Application Publication
(10) Pub. No.: US 2007/0053032 A1
(43) Pub. Date: Mar. 8, 2007

(54) Polarisation converter

(76) Inventor: Momcilo Milan Popovich, Leicester (GB)

Correspondence Address: POPOVICH, Milan, Momcilo, 53 Westfield Road, Leicester, ENG, LE3 6HU, GB

(21) Appl. No.: 11/514,851

(22) Filed: Sep. 5, 2006

(30) Foreign Application Priority Data
Sep. 8, 2005 (GB) GB 0518212.6

(51) Int. Cl. G02B 5/32

(52) U.S. Cl. 359/15; 359/19

(57) ABSTRACT

A polarisation control device is provided comprising in sequence an array of electrically switchable holographic lenses, a half wave plate and an electrically switchable beam deflecting holographic optical element. Said switchable holographic devices each operate on light having a first polarisation state. Light in a second orthogonal polarisation state is not affected by said switchable holographic devices. The half wave plate contains an array of apertures that overlap substantially with the focal regions formed by the holographic lenses. Light propagating through said apertures retains its polarisation state. The beam deflecting holographic optical element deflects and diffuses collimated input light. A further diffusing element may be used to apply additional diffusion to the light emerging from the beam deflecting holographic optical element. In a further embodiment of the invention the array of transmission holographic optical elements and the beam deflecting holographic optical elements each comprise a stack of red, green and blue transmitting switchable transmission holograms.

### BACKGROUND OF THE INVENTION

This application claims priority to United Kingdom Patent Application No. GB 0518212.6 filed 8 Sep. 2005.

This invention relates to a illumination device, and more particularly to a device that provides linearly polarized illumination from a randomly polarized light source.

LCDs are now found in a wide variety of applications, including directly viewed displays, virtual image displays, where the liquid crystal device is viewed through a magnifying optical system, and projection displays. One well-known approach for providing a colour display is to illuminate a monochromatic LCD device with red, green, and blue light in sequence at a sufficient rate such that the sequential single-colour images appear to the observer as a full colour image. Colour sequential illumination is commonly used for large screen projection displays. Early sequential-sequential displays employed a rotating colour filter wheel to filter the light from a white source into sequential red, green, and blue components.

One emerging illumination technology currently being considered for LCD applications is based on electrically switchable holograms. Such devices are formed by recording a volume phase grating in a polymer dispersed liquid crystal (PDLC) mixture. U.S. Pat. No. 5,942,157 and U.S. Pat. No. 5,751,452 describe monomer and liquid crystal material combinations suitable for fabricating Holographic PDLC (HPDLC) devices. A publication by Butler et al. (“Diffractive properties of highly birefringent volume gratings: investigation”, Journal of the Optical Society of America B, Volume 19 No. 2, Feb. 2002) describes analytical methods useful to design HPDLC devices and provides numerous references to prior publications describing the fabrication and application of HPDLC devices. U.S. Pat. No. 6,115,152 describes an apparatus for colour-sequential illumination of a display, which combines light from red green and blue illumination sources. The apparatus comprises a stack of electrically switchable holograms. Each switchable hologram diffracts light from one illumination source into a common direction, such that light is transmitted sequentially from each illumination source onto the display panel.

HPDLC transmission gratings suffer from the problem that the LC molecules tend to align normal to the grating fringe planes. The effect of the LC molecule alignment is that HPDLC transmission gratings efficiently diffract P polarized light (ie light with the polarization vector in the plane of incidence) but have nearly zero diffraction efficiency for S polarized light (ie light with the polarization vector normal to the plane of incidence.

Both LCDs and illuminators based on HPDLC transmission gratings require polarised illumination. The use of randomly polarised light sources therefore results in half the available illumination light being discarded. Although polarisation recycling techniques based on polarizing beams splitters and polarization retarders are well known in the field of displays they tend to be inefficient bulky and expensive for many display applications.

Thus there exists a need for an improved illumination system for LCDs that can provide linearly polarized sequential-sequential illumination from a randomly polarized source in a light efficient compact configuration.

### SUMMARY OF THE INVENTION

It is an object of the present invention to provide an improved illumination system for LCDs that can provide linearly polarized sequential-sequential illumination from a randomly polarized source in a light efficient compact configuration.

The objects of the invention are achieved in a first embodiment comprising an array of switchable holographic lenses, a Half Wave Plate (HWP) layer and a switchable beam deflecting Holographic Optical Element (HOE). The input light is typically provided by means of an illumination assembly comprising a set of LED sources and collimating lenses, which do not form part of the invention. The switchable holographic lens array operates on P-polarised input light. The HWP layer contains apertures through which light may propagate without polarization change. The HWPs switch the incident S-polarized light into the P-polarized state. The apertures in the HWP overlap substantially with the focal regions formed by the HOE array. The switchable beam deflecting HOE has diffusing properties such that a collimated P-polarized input beam is directed into a range of ray directions with an average direction substantially normal to the surface of the HOE. However, the P-polarized beam emerging from the holographic lens array is not deflected because it falls outside the angular bandwidth of the beam deflecting HOE.

The apparatus may further comprise a diffusing layer, which applies further diffusion to the P-polarized light emerging from the beam deflecting HOE.

The holographic lenses may have optical power in one plane only such that they form bar shaped focal regions. In such an embodiment of the invention the HWP layer comprises an array of bar shaped HWP elements separated by small gaps through which light may propagate without polarization change.

In another embodiment of the invention the holographic lens array and the beam deflecting HOE each comprise a stack of red, green and blue transmitting switchable holograms.

In a further embodiment of the invention the beam deflecting HOE is designed to deflect collimated input light without applying diffusion.

In a further embodiment of the invention the holographic lens array elements may provide optical power in two orthogonal planes and the HWP layer contains a grid of circular apertures through which light may propagate without polarizations change.

In a further embodiment of the invention the beam deflecting HOE is configured as an array of beam deflecting HOEs. The gaps between array elements substantially overlap the gaps between the elements of the HWP layer.

In a further embodiment of the invention the diffusing element has spatially varying scattering characteristics.

A more complete understanding of the invention can be obtained by considering the following detailed description in conjunction with the accompanying drawings wherein like index numerals indicate like parts. For purposes of clarity, details relating to technical material that is known in the technical fields related to the invention have not been described in detail.

### BRIEF DESCRIPTION OF THE DRAWINGS

FIG. 1 is a schematic side elevation view of a first embodiment of the invention.

FIG. 2 is a schematic front view of elements of the embodiment of FIG. 1

FIG. 3 is a chart showing the illumination distribution at then output of the illuminator.

FIG. 4 is a schematic side elevation view of a further embodiment of the invention.

FIG. 5 is a schematic side elevation view of a further embodiment of the invention.

FIG. 6 is a schematic side elevation view of a further embodiment of the invention.

FIG. 7 is a schematic front view of a further embodiment of the invention.

FIG. 8 is a schematic side elevation view of a further embodiment of the invention.

FIG. 9 is a schematic side elevation view of a further embodiment of the invention.

FIG. 10 is a schematic side elevation view of a further embodiment of the invention.

### DETAILED DESCRIPTION OF THE INVENTION

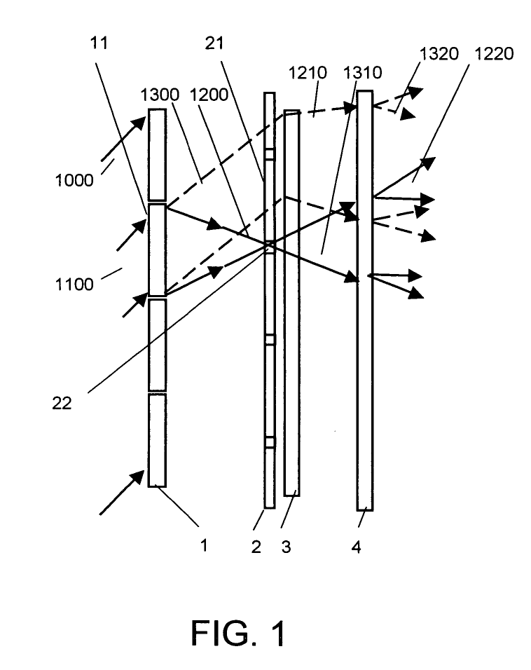

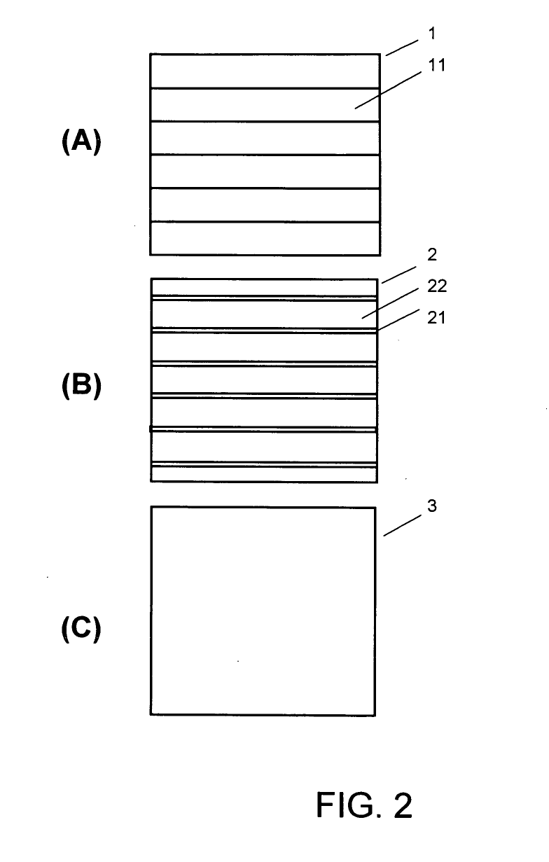

A schematic side elevation view of a first embodiment of the invention is shown in FIG. 1. A polarization control device according to the principles of the invention comprises an array of electrically switchable holographic lenses 1, a Half Wave Plate (HWP) layer 2, an electrically switchable beam deflecting HOE 3 and a diffusing element 4. The input light is typically provided by means of an illumination assembly comprising a set of LED sources and collimating lenses, which do not form part of the invention. Each switchable HOE comprises a HPDLC grating layer sandwiched between a pair of transparent substrates to which transparent electrode coatings have been applied. FIG. 2A shows a front elevation view of the switchable holographic lens array 1. FIG. 2B shows a front elevation view of the HWP layer 2. FIG. 2C shows a front elevation view of the switchable beam deflecting HOE 3. The holographic lens array 1 comprises bar-shaped holographic lens elements, such as 11. The holographic lenses have optical power in one plane only. Hence the holographic lens elements 11 are operative to form bar shaped focal regions. The switchable beam deflecting HOE 3 has diffusing properties such that a collimated input beam is directed into a range of ray directions with an average direction substantially normal to the grating. The HWP layer comprises an array of bar shaped elements such as 21. The HWP elements are separated by small gaps such as 22. The gaps essentially allow light to propagate without polarization change. The bar shaped apertures overlap substantially with the bar shaped focal regions.

Typically, HPDLC devices are fabricated by first placing a thin film of a mixture of photopolymerizable monomers and liquid crystal material between parallel glass plates.

Techniques for making and filling glass cells are well known in the liquid crystal display industry. One or both glass plates support electrodes, typically transparent indium tin oxide films, for applying an electric field across the PDLC layer. A volume phase grating is then recorded by illuminating the liquid material with two mutually coherent laser beams, which interfere to form the desired grating structure. During the recording process, the monomers polymerise and the HPDLC mixture undergoes a phase separation, creating regions densely populated by liquid crystal micro-droplets, interspersed with regions of clear polymer. The alternating liquid crystal-rich and liquid crystal-depleted regions form the fringe planes of the grating. The resulting volume phase grating can exhibit very high diffraction efficiency, which may be controlled by the magnitude of the electric field applied across the PDLC layer. When an electric field is applied to the hologram via transparent electrodes, the natural orientation of the LC droplets is changed causing the refractive index modulation of the fringes to reduce and the hologram diffraction efficiency to drop to very low levels. Note that the diffraction efficiency of the device can be adjusted, by means of the applied voltage, over a continuous range from near 100% efficiency with no voltage applied to essentially zero efficiency with a sufficiently high voltage applied.

The HWP layer may be formed by means of a mask process or by constructing the array from separate HWP elements. The HWP elements may be separated by a transparent optical medium. Alternatively, the HWP elements may be air separated. Alternatively, other methods known to those skilled in the art may be used to fabricate the HWP. The HPDLC substrates may be fabricated from glass or optical plastic.

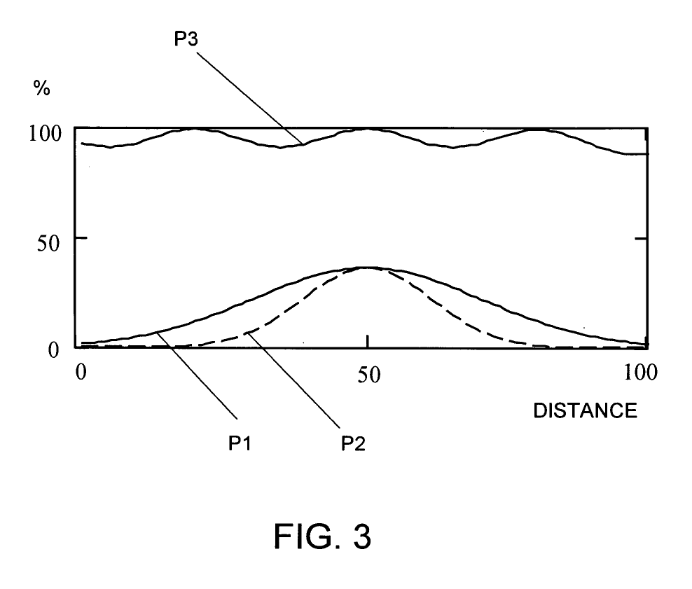

The diffuser 4 is designed to scatter incident light rays into a specified distribution of ray directions. The diffuser may be fabricated from conventional diffusing materials. Alternatively, the diffuser may be a holographic optical element such as, for example, a Light Shaping Diffuser manufactured by Precision Optical Corporation. FIG. 3 is a chart showing typical examples of the spatial intensity distribution cross sections at a plane located beyond the diffuser 4. The plane may correspond to the surface of an LCD device, for example. PI is a typical intensity distribution formed by the diffuser 4. P2 is a typical intensity distribution obtained from an element of the beam deflecting HOE 3, which operates on the S component of the incident light after it has been converted to P polarized light. P3 represents the resultant intensity distribution resulting from input light incident on three adjacent lens array elements in the holographic lens array 1. The non-uniformity of the intensity distributions PI and P2 results in ripple, which may cause unacceptable luminance variations in the display image. The ripple can be significantly reduced by controlling the diffusing characteristics of the beam deflecting HOE 3 and the diffuser 4. The diffuser may be a Computer Generated Hologram designed to convert input light comprising separated collimated and divergent components into a uniform intensity output beam. The basic principles of the design and fabrication of CGH devices suitable for use in the present invention are discussed in references such as. “Digital Diffractive Optics: An Introduction to Planar Diffractive Optics and Related Technology” by B. Kress and P. Meyrueis, published in 2000 by John Wiley & Sons Inc.

The basic principles of the invention are now explained with reference to FIG. 1. Input monochromatic collimated light generally indicated by 1000 is incident over the aperture of the HOE array 1. We consider the holographic lens array element 11, which is illuminated by the portion of illumination 1100. HPDLC transmission gratings efficiently diffract P polarized light (ie light with the polarization vector in the plane of incidence) but have nearly zero diffraction efficiency for S polarized light (ie light with the polarization vector normal to the plane of incidence. Hence, the P polarized component of input light 1100 is diffracted to form the converging beam generally indicated by 1300. Since the element 11 has lens-like properties in one plane, the converging beam 1300 forms a bar shaped focal region. Said focal region substantially overlaps the bar shaped aperture 22 in the half wave plate array 2. The diffracted light emerges from the HWP layer as the diverging beam 1310. The beam 1310 then passes through the beam deflecting HOE 3 without being diffracted, since the incident directions of 1310 do not satisfy the Bragg condition of HOE 3, since said element is designed to deflect collimated light at steep incidence angles. The basic principles of Bragg diffraction will be well known to those skilled in the art of holography and are discussed in textbooks such as “Optical Holography” by R. J. Collier, C. B. Burkhardt and L. H. Lin published by Academic Press, New York (1971). The beam 1310 propagates onto the surface of the diffuser 4. The diffuser causes the incident light 1310 to be scattered into a range of angles generally indicated by 1320. We next consider the propagation of the S-polarized component of the incident light portion 1 100. The S-polarized component of the input light is not diffracted by the holographic lens array 1.

The S-polarized light propagates in the zero order direction represented by 1200. After propagation through the half wave plate array, the polarization of the beam 1200 is converted from S to P. The converted P polarized light is now diffracted by the beam deflecting HOE into a range of ray directions, generally indicated by 1210, with an average direction substantially normal to the grating. The light 1210 is then transmitted through the diffuser layer 4, which further modifies the diffusion profile of the light to give the diffuse output ray distribution generally indicated by 1220. The average direction of the rays 1220 is substantially normal to the diffuser layer 4.

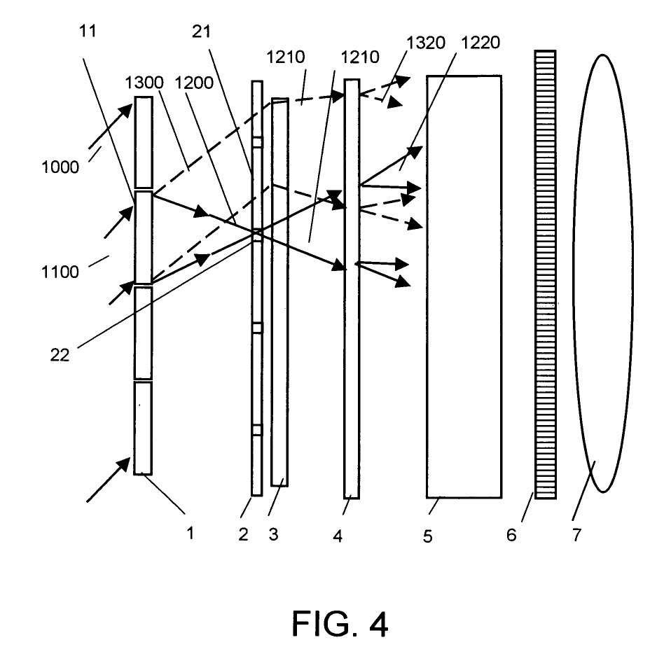

FIG. 4 is a schematic side elevation view of the embodiment of FIG. 1 implemented in a projection system. The projection system further comprises relay optics 5, a transmission flat panel display 6 and a projection lens 7.

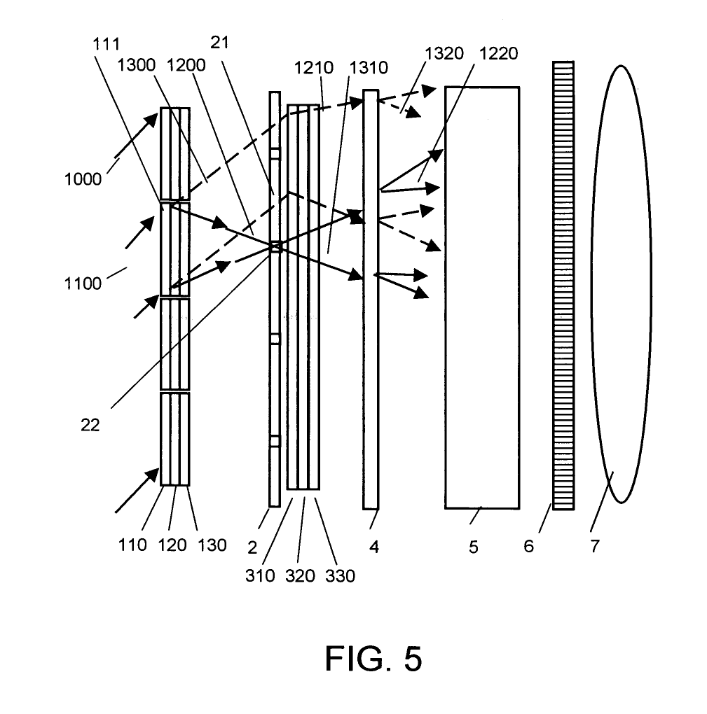

FIG. 5 is a schematic side elevation view of an embodiment of the invention configured for colour sequential illuminations. In FIG. 5 the switchable HOE devices 1 and 3 are replaced by the red green and blue switchable holographic lens arrays 110,120,130 and the red green and blue switchable beam deflecting HOEs 310,320,330 respectively. The combined HOEs are operative to direct red, green and blue light, in sequence towards the display panel 6 in a direction substantially normal to the surface of the display panel. To transmit red light the holographic lens arrays 120 and 130 and the beam deflecting HOEs 310 and 320 are inactive while the holographic lens layer 110 and the holographic layer 320 are activated. The red light is then transmitted through the system in accordance with the basic principles discussed above. The green and blue layers are then activated in sequence in accordance with the above procedure to provide colour sequential illumination of the display panel.

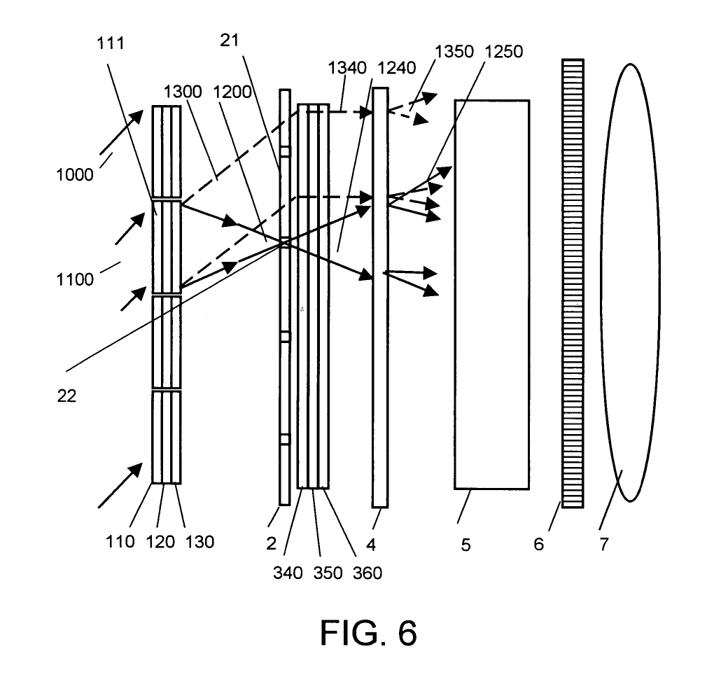

FIG. 6 shows a further embodiment of the invention similar to the embodiment of FIG. 5. However, in FIG. 6 the beam deflecting HOEs 340,350,360 are operative to switch light without diffusion. Hence, the incident rays emerge as the parallel rays generally indicated by 1340.

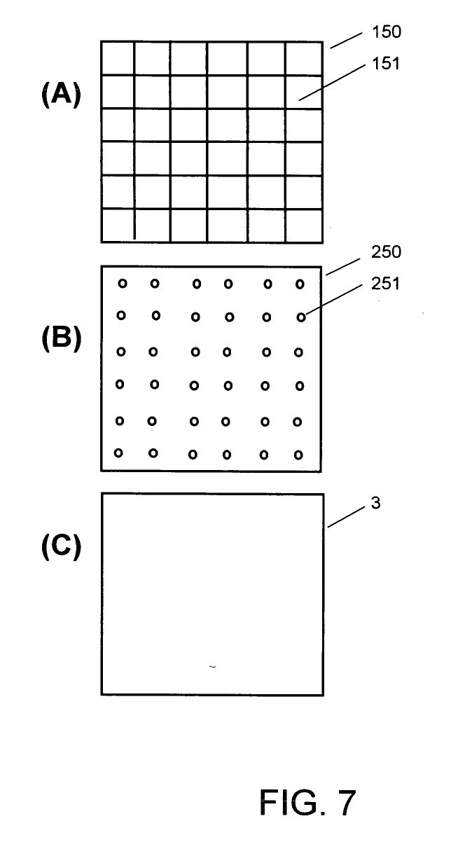

Although the invention has been described in terms of an array of bar shaped lens elements that focus the incident light into a bar shaped focal region, in further embodiments of the invention the switchable lens array may be a two dimensional array operative to form focal spots rather than bar shaped focal regions. FIG. 7A shows a front elevation view of the switchable holographic lens array 150. FIG. 7B shows a front elevation view of the HWP layer 250. FIG. 7C shows a front elevation view of the switchable beam deflecting HOE 3. Referring to FIG. 7 it can be seen that the holographic lens array elements 151 are configured as a two dimensional array. The lens array elements may be holographic microlenses with spherical or aspheric forms. The HWP layer now contains apertures 251 centred on the lens elements. Said apertures may be circular or of other shapes advantageously matched to the focal spot shapes of the holographic lens array elements. It will be clear to those skilled in the art that the schematic views of FIGS. 1-6 may also be used to represent equivalent embodiments of the inventions based on two-dimensional arrays.

In the embodiments discussed above the diffracted beam 1200 and the zero order beam 1300 will have appreciably different ray angles. The rays in beam 1200 will tend to have much steeper incidence angles. Hence, the rays 1310 will fall outside the angular bandwidth of the beam deflecting HOE 3 and will not be diffracted with high efficiency. However, if the lenses in the holographic lens array are designed to have a high optical power, some of the rays 1310 may fall within the angular bandwidth of the beam deflecting HOE 3.

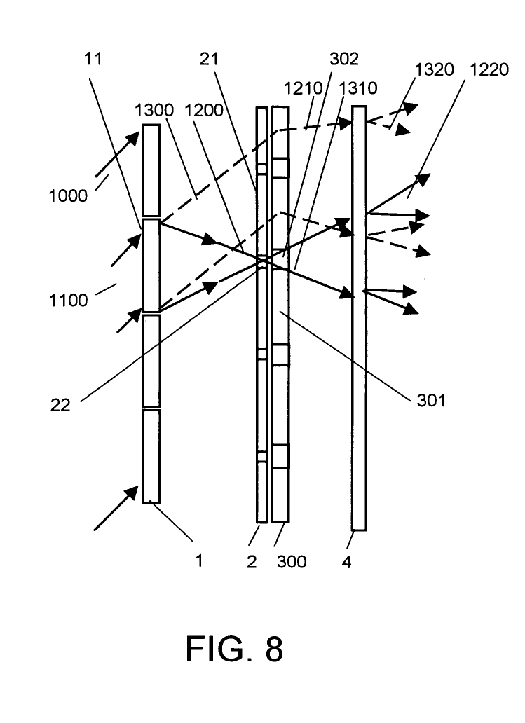

FIG. 8 shows an alternative embodiment of the invention in which the beam deflecting HOE 300 is an array of bar shaped beam deflecting HOEs 301 each having identical properties to the beam deflecting HOE of the earlier embodiments. The HOE elements are separated by apertures such as 302, which overlap the apertures 22 of the HWP as shown in FIG. 8. Alternatively, FIG. 8 may represent an embodiment in which the beam deflecting HOE 3 comprises a two dimensional array of beam deflecting HOEs

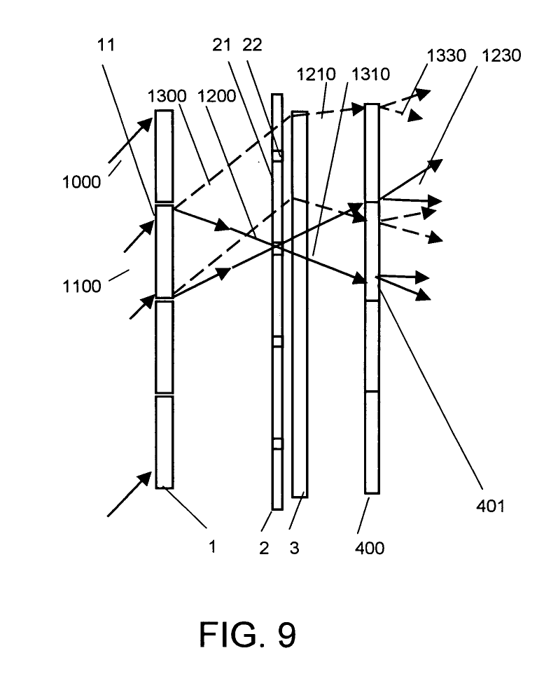

FIG. 9 shows a further embodiment of the invention similar to the embodiment of FIG. 1. However in FIG. 9 the diffuser layer 4 is replaced with a diffuser layer 400 composed of an array of bar shaped diffusers such as 401, with identical non-uniform scattering characteristics. The output rays from the diffuser element 401 are generally indicated by 1320. The use of a diffuser array allows more precise control of the output illumination distribution. Alternatively, FIG. 9 may represent an embodiment in which the diffuser comprises a two dimensional array of diffusing elements.

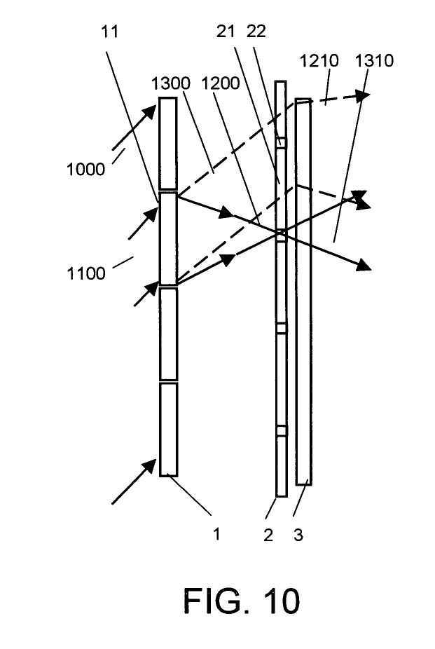

FIG. 10 shows a further embodiment of the invention similar to the embodiment of FIG. 1. However in FIG. 10 the diffuser layer 4 is eliminated. Incorporating suitable diffusion characteristics into the beam deflecting HOE provides output beam illumination characteristics similar to those of the embodiment of FIG. 1. The techniques for forming HOEs with diffusing characteristics are well known to those skilled in the art of holography.

Although the invention has been discussed in terms of switchable HOEs, it will be clear from consideration of the above description that in certain applications the invention may be implemented using non switchable HOE devices to perform the functions of the lens array and the beam deflector.

The basic principle of the present invention may be applied to a wide range of display applications including LED illuminators for video projectors, LCD backlights and others.

To ensure efficient use of the available light and a wide colour gamut for the display, each HPDLC device should be substantially transparent when a voltage is applied and, preferably, should diffract only the intended colour without an applied voltage.

It should be emphasized that FIGS. 1 to 10 are exemplary and that the dimensions have been exaggerated. For example, thicknesses of the switchable holographic elements and the HWP layer have been greatly exaggerated.

Although the invention has been described in relation to what are presently considered to be the most practical and preferred embodiments, it is to be understood that the invention is not limited to the disclosed arrangements, but rather is intended to cover various modifications and equivalent constructions included within the spirit and scope of the invention.

What is claimed is:

1. A polarisation control device comprising in sequence:
an input port operative to admit non polarised light;
a first array of switchable holographic lenses operative to diffract light at a first wavelength;
a half wave plate;
a first switchable holographic beam deflector operative to diffract light at said first wavelength; and
an output port operative to transmit light having a first linearly polarised state,
wherein said holographic lenses and said holographic beam deflector each operate on light in said first linearly polarised state,
wherein said beam deflector is operative to diffract light in said first linearly polarised state towards said output port,
wherein said half wave plate contains an array of apertures operative to transmit light without polarisation change,
wherein said lenses form an array of focal regions, and
wherein said apertures overlap substantially with said focal regions.

2. The apparatus of claim 1 further comprising second and third arrays of switchable holographic lenses operative to diffract second and third wavelength light respectively,
wherein said first, second and third arrays are disposed in sequence between said first array of switchable holographic lenses and said half wave plate,
wherein the focal regions of said first second and third arrays of switchable holographic lenses overlap, and
wherein said second and third arrays of switchable holographic lenses each operate on light in said first linearly polarised state.

3. The apparatus of claim 1 further comprising second and third switchable holographic beam deflectors operative to diffract second and third wavelength light respectively,
wherein said first, second and third arrays are disposed in sequence after said first switchable holographic beam deflector,
wherein said second and third switchable holographic beam deflectors each operate on light in said first linearly polarised state, and
wherein said second and third switchable holographic beam deflectors diffract light in said first linearly polarised stated towards said output port.

4. The apparatus of claim 2 wherein at least one of said first, second and third switchable holographic lenses has diffusing characteristics.

5. The apparatus of claim 3 wherein at least one of said first, second and third switchable holographic beam deflectors has diffusing characteristics.

6. The apparatus of claim 2 wherein said first, second and third arrays of switchable holographic lenses are configured as a stack.

7. The apparatus of claim 3 wherein said first, second and third switchable holographic bean deflectors are configured as a stack.

8. The apparatus of claim 1 wherein said switchable holographic beam deflector contains an array of apertures, wherein said beam deflector apertures overlap with said half wave plate apertures.

9. The apparatus of claim 1 wherein said lenses each have axisymmetric power, wherein said array of focal regions comprises a two dimensional array of focal spots, and wherein said array of half wave plate apertures comprises a two dimensional array of circular apertures.

10. The apparatus of claim 1 wherein said lenses each have power in one plane only, wherein said array of focal regions is a grid of focal lines, and wherein said array of half wave plate apertures comprises a grid of rectangular apertures.

11. The apparatus of claim 1 wherein at least one of said array of switchable holographic lenses and said switchable holographic beam deflector are recorded in a holographic polymer dispersed liquid crystal material.

12. The apparatus of claim 1 wherein at least one of said array of switchable holographic lenses and said switchable holographic beam deflector are Electrically Switchable Bragg Gratings.

13. The apparatus of claim 1 wherein said holographic deflector has diffusing properties.

14. The apparatus of claim 1 further comprising a diffusing optical element disposed after said switchable holographic beam deflector.

15. The apparatus of claim 14 wherein said diffusing optical element has spatially varying scattering characteristics.
